(19) United States
(12) Patent Application Publication
(10) Pub. No.: US 2007/0252707 A1
(43) Pub. Date: Nov. 1, 2007

(54) Dual Use Anti-theft Tag

(76) Inventor: Stuart Seidel, Boca Raton, FL (US)

Correspondence Address: JOHN C. SMITH, ESQ., 2499 GLADES ROAD, SUITE 113, BOCA RATON, FL, 33431, US

(21) Appl. No.: 11/742,537

(22) Filed: Apr. 30, 2007

Related U.S. Application Data
(60) Provisional application No. 60/795,741, filed on Apr. 29, 2006.

(51) Int. Cl. G08B 13/14

(52) U.S. Cl. 340/572.9

(57) ABSTRACT

A dual use anti-theft tag is provided which has a structure that can be used as a reusable anti-theft tag, or as a single use recyclable anti-theft tag. The anti-theft tag uses a conventional ball bearing lock which can be opened by a mechanical probe, or opened magnetically. In a first configuration, the anti-theft tag uses a reusable locking mechanism. In this configuration, the lock can be repeatedly moved from a locked to an unlocked position. In a recyclable configuration, an optional spring lock keeps the anti-theft tag in the unlocked position once opened. An advantage of the invention is that the same anti-theft tag structure can be used for both embodiments.

### CROSS-REFERENCE TO RELATED APPLICATIONS

This application is related to, and claims the benefit of, the provisional patent application entitled “Dual Use Anti-Theft Tag”, filed Apr. 29, 2006, bearing U.S. Ser. No. 60/795,741 and naming Stuart T. Seidel, the named inventor herein, as sole inventor, the contents of which is specifically incorporated by reference herein in its entirety.

### TECHNICAL FIELD

The present invention relates to anti-theft devices which attach to commodities for preventing theft of the commodity. In particular, it relates to removable anti-theft devices having an anti-theft which triggers an alarm when it is removed from a monitored area, and a removable securing member for attaching the anti-theft to the commodity. The anti-theft tag reduces manufacturing expenses by allowing the same anti-theft structure to be used for two functions. In particular, it is an improved dual use anti-theft structure that can be implemented as a reusable anti-theft, or alternatively be implemented a single use recyclable anti-theft which can be opened via a mechanical probe or magnetically. The recyclable anti-theft tag also reduces retailer expenses. This is accomplished by attaching the anti-theft tag to a product at the product manufacturing site and shipping it with the product from the product manufacturer to the product retailer (e.g., clothing manufacturer, etc.), the product manufacturer ships the complete product with anti-theft tag to the retailer, who removes the tag at the point-of-sale and returns it to the tag manufacturer. The tag manufacturer then resets the tag and returns it to the product manufacturer.

### BACKGROUND

Theft of all kinds has been an ongoing problem for virtually all retail establishments. One kind of theft, shoplifting, has caused substantial damage to retailers due to its widespread nature. In an attempt to address this problem, a variety of devices have been developed to limit shoplifting losses by automatically alerting the retailer when an item of merchandise is being illegally removed from the premises.

One type of anti-theft device is the anti-theft tag. An anti-theft tag is typically a small device which is secured to an item. The anti-theft tag typically includes a tuned circuit or antenna device which communicates with detectors placed at the entrances to the retailer's premises. When the detector senses a tag being removed from the store, it alerts the retailer via an alarm that is controlled by the detector.

Anti-theft tags of this type typically contain a first part which holds the tuned circuit or antenna, along with mechanical methods of securing the first part to a second part which is a securing means. A securing means is typically a cap-like structure with a securing pin. The securing pin is pushed through an item, such as a garment, and then secured to the first part. Once a customer has made a purchase, the employee removes the anti-theft tag so the customer can take the item out of the store without setting off an alarm.

Removing the securing means from the anti-theft tag can be done in several ways. One method is to insert a probe which applies pressure to the securing means to force it to release the pin. Unfortunately, shoplifters quickly developed mechanical devices to insert into the anti-theft tag and allow it to be removed from the inventory item. In response, the anti-theft industry has developed a variety of devices designed to defeat the attempts of shoplifters to remove anti-theft tags.

Another type of anti-theft tag uses a magnetic lock in place of the probe actuated lock previously discussed. It would be desirable to reduce anti-theft manufacturing costs with an anti-theft tag that can be used with conventional probe actuated and/or magnetic locks.

One attempt to make an inexpensive anti-theft tag has been to make them single-use disposable tags. These tags have been successful in the sense that they are inexpensive. However, they have also created environmental problems due to the huge numbers of tags that become refuse. It would be desirable to have a method of reusing disposable tags so that the environmental problems were avoided. Further, it would be desirable to have a method of reusing these tags in a manner that would further reduce costs.

Another problem associated with prior art anti-theft tags is the cost that retailers bear in regard to their use. In particular, retailers bear a high cost due to the time required to attach anti-theft tags to inventory. It would be desirable to have a method of using the anti-theft tags in a manner which incurred the minimum cost to retailers.

While anti-theft tags save retailers a substantial amount of expense by reducing theft, they are also costly due to how they are used. Currently, retailers attach anti-theft tags to their products at the retail location. Unfortunately, attaching anti-theft tags to garments creates substantial costs for retailers. For example, the more expensive labor costs are in a particular area, the more expensive it is to have employee's attach these anti-theft tags to merchandise at the retail establishment. It would be desirable to have a method of reducing retailer costs by eliminating or reducing the cost of attaching anti-theft tags to merchandise.

While the prior art has provided numerous types of anti-theft tags, it has failed to provide an anti-theft tag that can be unlocked with a probe or via a magnetic field, and which can be used as a reusable anti-theft tag or as a single use recyclable anti-theft tag.

### SUMMARY OF INVENTION

The present invention solves the foregoing problems by providing a single anti-theft tag structure that can be used as a reusable anti-theft tag or as a single use recyclable anti-theft tag. The anti-theft tag uses a conventional ball bearing lock which can be opened by a conventional probe, or by a magnetic unlocking device.

In a single use embodiment, a locking mechanism is used to keep the anti-theft tag in the unlocked position once opened. This embodiment is the single use recyclable anti-theft tag. It reduces retailer cost by pre-attaching anti-theft tags to merchandise prior to shipment to the retailer. The system uses a locking mechanism which only allows the anti-theft tag to be used once by a retailer. Initially, the anti-theft tag manufacturer ships the anti-theft tags to a merchandise manufacturer who applies the anti-theft tags to the merchandise. The merchandise is then shipped, with the tag, to the retailer. The retailer removes the anti-theft tag at the point-of-sale, and returns the tag to the anti-theft tag manufacturer. This eliminates the retailer's expense related to attachment of the tags to the merchandise. The anti-theft tag uses a locking mechanism which locks the ball bearing clutch in the open position when unlocked. The retailer returns the anti-theft tag to the anti-theft tag manufacturer who resets the ant-theft tag and ships it to the product manufacturer.

An alternative embodiment of the anti-theft tag uses a reusable locking mechanism. In this embodiment, the lock can be repeatedly moved from a locked to an unlocked position. An advantage of the invention is that the same anti-theft tag structure can be used for both embodiments.

### BRIEF DESCRIPTION OF THE DRAWINGS

FIG. 1 is a perspective view of a preferred embodiment of the bottom portion of an anti-theft tag which illustrates the ball bearing lock used to hold the securing pin.

FIG. 2 is a top view of a preferred embodiment of the top and bottom portions of an anti-theft tag which illustrates the ball bearing lock, the probe actuated lock lever and the antenna device.

FIG. 3 is a top view of a preferred embodiment of the probe actuated lock lever.

FIG. 4 is a bottom view of a preferred embodiment of the probe actuated lock lever.

FIG. 5 is a side view of a preferred embodiment of the probe actuated lock lever.

FIG. 6 is a perspective view of a preferred embodiment of the probe actuated lock lever.

FIG. 7 is a top view of a preferred embodiment of the bottom portion of an anti-theft tag which illustrates the ball bearing lock and the probe actuated lock lever.

FIG. 8 is a close-up view of a preferred embodiment of the bottom portion of an anti-theft tag which illustrates the ball bearing lock and the probe actuated lock lever. The locking groove on the ball bearing lock is also shown.

FIG. 9 is a top view of a preferred embodiment of the bottom portion of an anti-theft tag which illustrates the ball bearing lock and the locking spring.

FIG. 10 is a top view of a preferred embodiment of the bottom portion of an anti-theft tag which illustrates the ball bearing lock, the locking spring, and the probe actuated lock lever.

### DETAILED DESCRIPTION

Prior to a detailed discussion of the figures, a general overview of the system will be presented. For purposes of this disclosure, the term “pick” will be used to refer to any device used by an unauthorized person to attempt to release the anti-theft tag from its securing member.

This invention provides new embodiments that are improvements over the prior art. In particular, the invention provides reusable anti-theft tags that reduce cost, are more convenient for the consumer, and are better for the environment. Further, the same anti-theft tag body can be used as a reusable anti-theft tag, or as a single use recyclable tag. Changing the anti-theft tag from a reusable configuration to a single use configuration is accomplished by adding a straight spring lock to prevent the anti-theft tag from returning to the locked position once opened. As a result, substantial manufacturing savings are achieved by allowing the same anti-theft tag to be used for either reusable anti-theft tags or single use recyclable anti-theft tags.

In a preferred embodiment, the invention uses a conventional ball bearing lock which is commercially available and well known in the art. When the anti-theft tag is secured to merchandise via a securing pin, the ball bearing lock prevents the securing pin from being detached. Securing pins are commercially available and are also well known in the art. In a preferred embodiment, a pivoting plate is arranged above the ball bearing lock. When the pivoting plate is tilted by a mechanical probe during the unlocking process, the pivoting plate presses down on the ball bearing lock and releases the securing pin. Once the mechanical probe is withdrawn, the ball bearing lock returns to its locked position. Alternatively, the ball bearing lock can be released magnetically by applying a strong magnetic field to it. Magnetic release mechanisms are also commercially available and are also well known in the art. Once the magnetic field is removed, the ball bearing lock returns to the locked position.

The same anti-theft tag structure used by the preferred embodiment (i.e., the reusable anti-theft tag) can also be used for an alternative preferred embodiment that is a single use recyclable anti-theft tag. The recyclable anti-theft tag is identical to the reusable tag in except that it adds an optional retaining spring that engages a slot on the side of the securing pin channel when the anti-theft tag is unlocked. Once engaged, the anti-theft tag remains in the unlocked position. The merchant then sends the recyclable tags back to the tag manufacturer where it is reset and sent to a product manufacturer where it is reattached to a new product and sent to a retailer. This process eliminates the need for the retailer to do anything insofar as attaching anti-theft tags to products is concerned. This results in savings of time and expense for the retailer. In addition, this process also is environmentally friendly in that it reuses the anti-theft tag rather than discarding it each time a retailer makes a sale. The use of the same anti-theft tag structure for both the reusable and recyclable anti-theft tags also reduces manufacturing costs by using the same design.

Having discussed the features and advantages of the invention in general, we now turn to a detailed discussion of the figures.

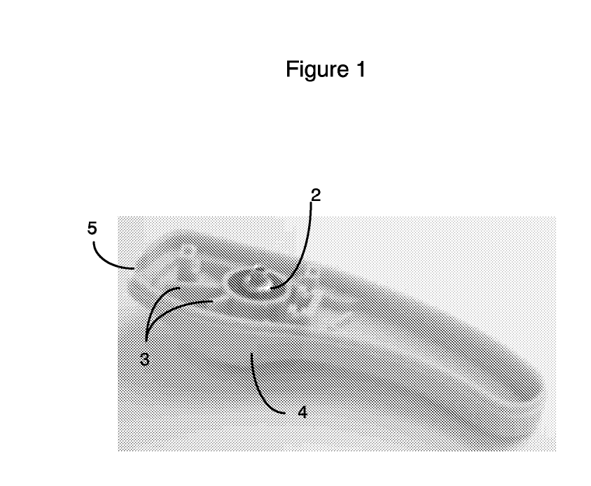

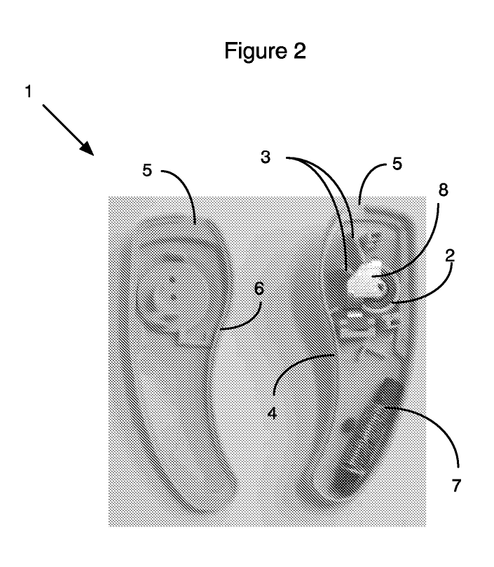

FIG. 1 is a perspective view of a preferred embodiment of the bottom portion 4 of an anti-theft tag 1 (illustrated in FIG. 2) which illustrates the ball bearing lock 2 used to hold the securing pin (not shown). Securing pins are well known in the art and are typically attached to a retaining button (not shown). Ball bearing locks 2 are commercially available and well known in the art. Also shown in this figure are pick diversion prongs 3 which are used to prevent a pick from accessing the lock lever 8 (shown in FIG. 2). Opening 5, which is used to allow a mechanical prong to access and tilt lock lever 8 to unlock ball bearing lock 2. In addition, the lock is designed to use a magnetic ball bearing lock 2 that can be unlocked with a magnetic field.

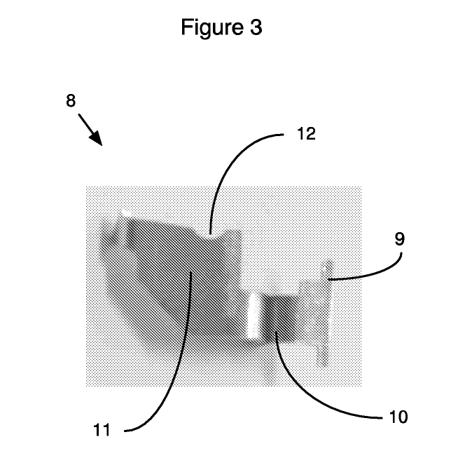

FIG. 2 is a top view of a preferred embodiment of the top 6 and bottom 4 portions of an anti-theft tag 1. This figure illustrates the ball bearing lock 2, which is arranged under tilt lock lever 8. When the tilt lever lock 8 is activated by a mechanical probe, the pressure plate 11 (shown in FIG. 3) tilts downward and presses ball bearing lock 2 which then moves to the unlocked position. Also shown in the figure is the antenna device 7.

FIG. 3 is a top view of a preferred embodiment of the lock lever 8. It includes the pressure plate 11, lever arm 10, pivot hinge 9 and a notch 12 designed to avoid the pin slot on the ball bearing lock 2.

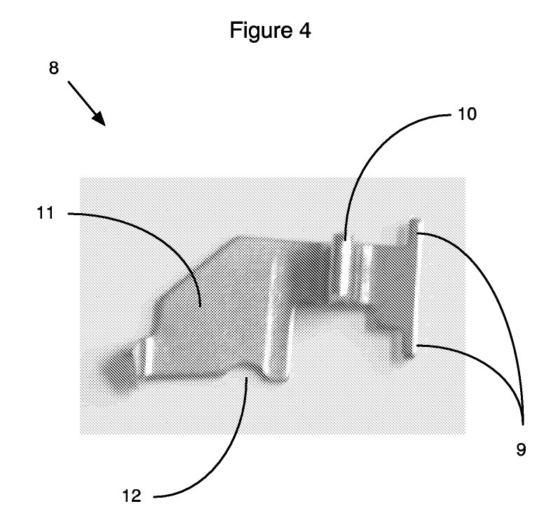

FIG. 4 is a bottom view of a preferred embodiment of the lock lever 8. It also illustrates the pressure plate 11, lever arm 10, pivot hinge 9 and a notch 12 that is designed to avoid the pin slot on the ball bearing lock 2.

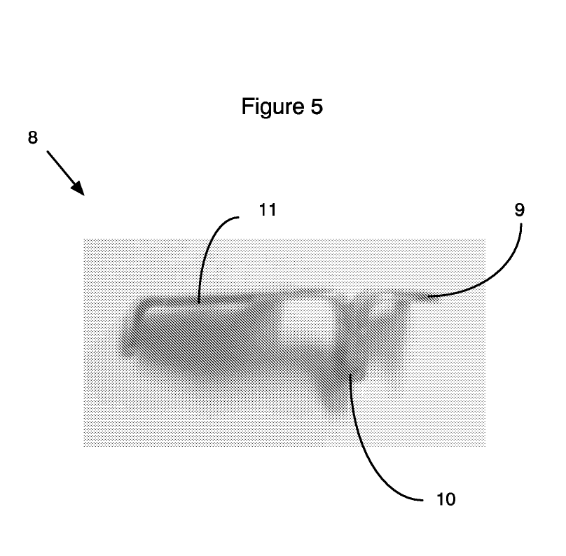

FIG. 5 is a side view of a preferred embodiment of the lock lever 8. It also illustrates the pressure plate 11, lever arm 10, and pivot hinge 9.

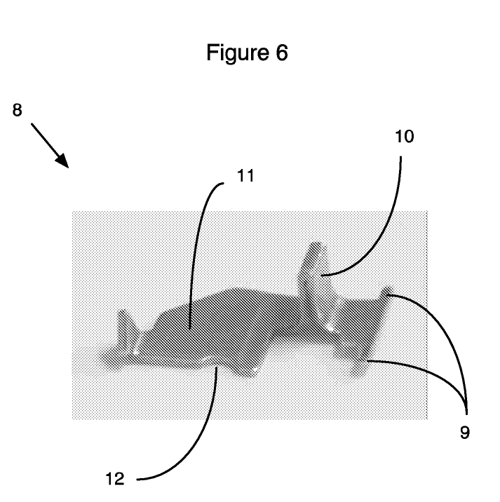

FIG. 6 is a perspective view of a preferred embodiment of the lock lever 8. It also illustrates the pressure plate 11, lever arm 10, pivot hinge 9 and a notch 12 designed to avoid the pin slot on the ball bearing lock 2.

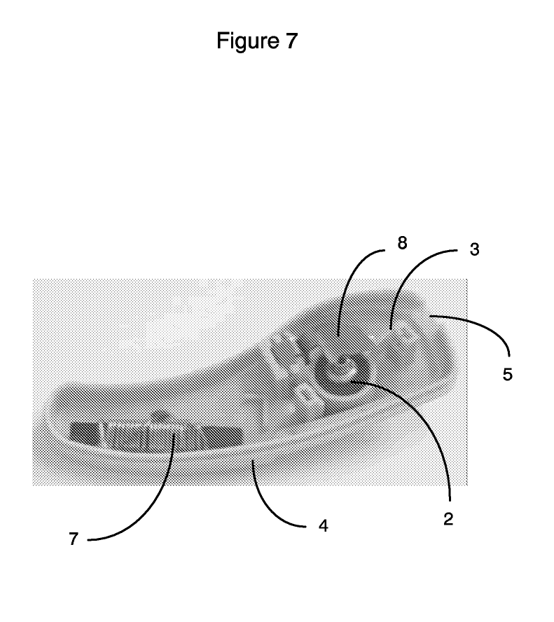

FIG. 7 is a top perspective view of a preferred embodiment of the bottom portion 4 of an anti-theft tag 1 which illustrates the ball bearing lock 2 positioned under the lock lever 8. As shown in this figure, pivot hinge 9 is positioned in a slot in a post extending from the bottom portion 4 of the anti-theft tag 1.

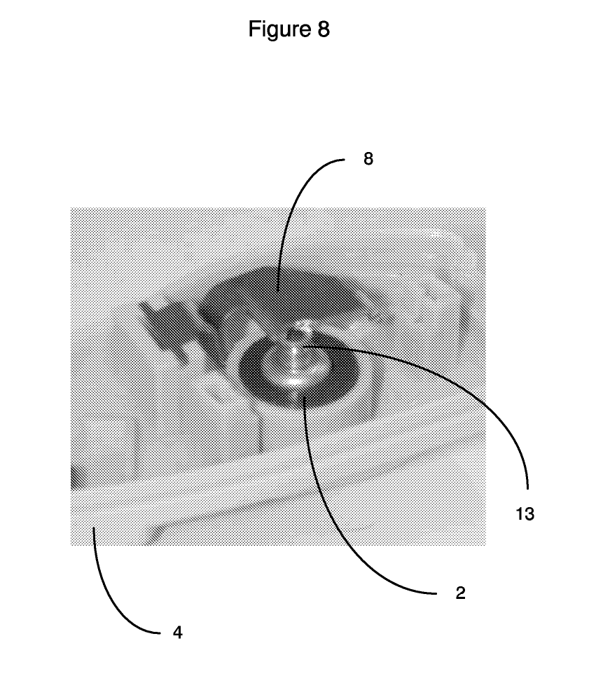

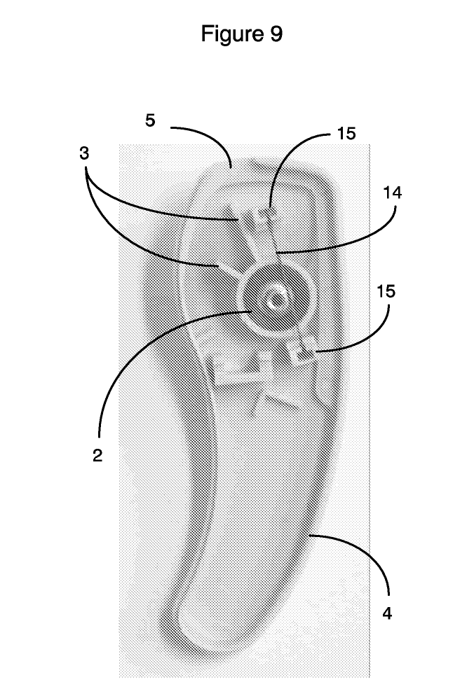

FIG. 8 is a close-up view of a preferred embodiment of the bottom portion 4 of an anti-theft tag 1 which illustrates the ball bearing lock and the lock lever 8. Also shown is a locking groove 13 which is preferably positioned on the securing pin channel on the ball bearing lock 2. The locking groove 13 is used by a retaining spring 14 (shown below in FIG. 9) to secure the ball bearing lock 2 in the unlocked position. An advantage of the design used by the invention is that the same ball bearing lock 2 can be used by a reusable anti-theft tag 1 or a recyclable anti-theft tag 1.

FIG. 9 is a top view of a preferred embodiment of the bottom portion 4 of an anti-theft tag 1 which illustrates the ball bearing lock 2 and the locking spring 14. The locking spring 14 is secured in place by retaining posts 15 on either end of the locking spring 14.

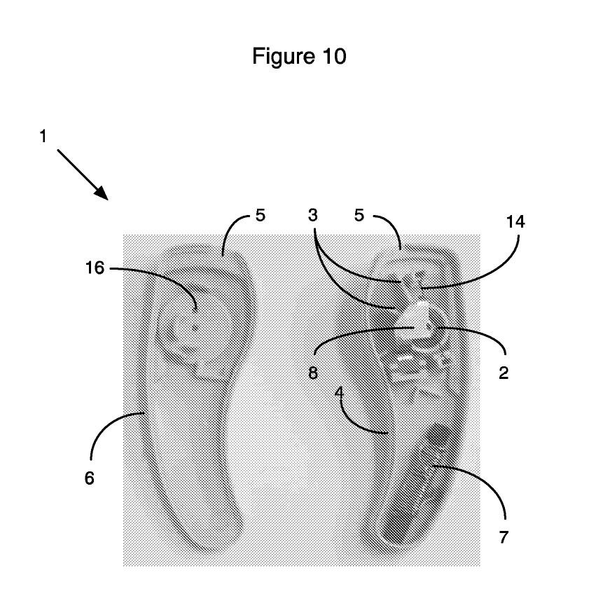

FIG. 10 is a top view of a preferred embodiment of the anti-theft tag 1 which illustrates the ball bearing lock 2 positioned under lock lever. In addition, the locking spring 14 is shown positioned to lock the ball bearing lock 2 in the open position. The top 6 of anti-theft tag 1 also has an aperture 16 which is intended to provide access by an unlocking probe (not shown), such as a key, which is inserted and turned to flex the locking spring 14. When locking spring 14 is flexed, it moves away from locking groove 13 and the ball bearing lock 2 returns to the locked position. In the preferred embodiment, aperture 16 is located under the securing pin's button such that the interior of the anti-theft tag 1 cannot be accessed through aperture 16 when the ant-theft tag 1 is attached to merchandise.

In use, the anti-theft tag can be opened by either of two methods. First, when magnetically opened, the ball bearing lock 2 is moved to the release position by the magnetic field. Second, if the anti-theft tag 1 is mechanically released by a conventional detacher arm (not shown), the detacher arm enters the anti-theft tag 1 at opening 5. The detacher arm presses against pressure plate 11, which in turn moves the lock lever 8 against the ball bearing lock 2. When this happens, the ball bearing lock 2 moves to the release position. In either case, the securing pin can be removed and the anti-theft tag 1 is detached from the merchandise.

If the anti-theft tag 1 is the reusable embodiment, the securing pin is removed and the anti-theft tag 1 is then removed from the merchandise. The anti-theft tag 1 is then available for reuse. Alternatively, if the anti-theft tag 1 is the recyclable embodiment, when it is released, it is locked in the release position by locking spring 14. In this embodiment, the anti-theft tag 1 is then returned to the tag manufacturer for attachment to new merchandise. These embodiments envision the anti-theft tag 1 being manufactured by an anti-theft tag 1 manufacturer who ships the anti-theft tags 1 to a merchandise manufacturer. The merchandise manufacturer then attaches the anti-theft tags 1 to merchandise which is then shipped to a retailer. When the retailer makes a sale, the anti-theft tag 1 is detached and returned to the anti-theft tag 1 manufacturer. This provides a significant benefit to the retailer because they obtain merchandise with the anti-theft tags 1 pre-attached, thereby minimizing any retailer cost associated with the attachment and use of the anti-theft tags 1. In addition, these embodiments provide a significant benefit in that, by recycling the anti-theft tags 1, they eliminate the environmental costs associated with disposable tags.

As can be seen from the foregoing, the anti-theft tag 1 structure set forth herein provides the retailer with low-cost method of providing anti-theft protection by shifting the cost of attaching the anti-theft tags 1 to the merchandise manufacturer. It further is environmentally friendly in that it reuses anti-theft tags 1 rather than discarding them after each sale. The design also provides an anti-theft tag 1 that can be used with both a mechanical and/or a magnetic detacher device. As a result, retailers can use the new anti-theft tags 1 without replacing their detacher devices. The embodiments provided herein disclose a reusable anti-theft tag that can be reattached to merchandise, or alternatively, a recyclable anti-theft tag that is reset by the anti-theft tag manufacturer. As a result, the retailer needs only to remove the recyclable anti-theft tags from the merchandise, and ship them in bulk to the anti-theft tag manufacturer for subsequent reuse.

While the invention has been described with respect to a preferred embodiment thereof, it will be understood by those skilled in the art that various changes in detail may be made therein without departing from the spirit, scope, and teaching of the invention. For example, the material used to construct the components of the anti-theft tag may be anything suitable for their purpose, the size and shape of the anti-theft tag can vary, etc. The spring lock can vary. Accordingly, the invention herein disclosed is to be limited only as specified in the following claims.

I claim:

1. An anti-theft tag, further comprising:
a bottom portion having a lock;
a top portion having a securing pin that attaches to the bottom portion;
the bottom portion having a ball bearing lock to secure the securing pin;
the ball bearing lock having means to be magnetically opened;
a locking lever positioned above the ball bearing lock such that the locking lever will pivot downward to unlock the ball bearing lock when a mechanical probe is inserted into the anti-theft tag;
a locking spring that engages the ball bearing lock when it is opened such that the ball bearing lock remains in the unlocked position; and
the lock secures the securing pin to the bottom portion prior to being opened, and remains in the unlocked position after being opened.
